(19) United States
(12) Patent Application Publication
(10) Pub. No.: US 2019/0277679 A1
(43) Pub. Date: Sep. 12, 2019

(54) METHOD FOR OPERATING A MAGNETIC-INDUCTIVE FLOW METER AND A MAGNETIC INDUCTIVE METER

(71) Applicant: Endress+Hauser Flowtec AG, Reinach (CH)

(72) Inventors: Florent Tschambser, Hesingue (FR); Markus Rüfenacht, Therwil (CH)

(21) Appl. No.: 16/463,166

(22) PCT Filed: Oct. 10, 2017
(86) PCT No.: PCT/EP2017/075858

§ 371 Date: May 22, 2019

(30) Foreign Application Priority Data
Nov. 22, 2016 (DE) 10 2016 122 495.2

(51) Int. Cl. G01F 1/58; G01F 1/60

(52) U.S. Cl. CPC G01F 1/588; G01F 1/60

(57) ABSTRACT

The present disclosure relates to a method for operating a magnetic-inductive flow meter. The method includes steps of generating a magnetic field in a medium during a feeding phase, wherein the feeding phase has a shot phase and a measuring phase, and measuring a coil current. The method also includes switching over from the shot phase to the measuring phase as soon as the coil current reaches a limit value, recording a time period from the beginning of the feeding phase to reaching the limit value, and determining a deviation of the time period from a target time period. The method further includes generating the magnetic field during a subsequent feeding phase, where a shot voltage of the subsequent feeding phase is adapted in dependence on the deviation in order to reduce the deviation of the time period from the target time period of the next feeding phase.

The invention relates to a method for operating a magnetic-inductive flow meter for measuring the flow rate or the volumetric flow of a medium in a measuring tube, and to a magnetic-inductive measuring device.

Magnetic-inductive flow meters use an opposite movement of electrical charges of different polarity in a medium flowing through a measuring tube, which medium moves perpendicular to a magnetic field generated by a magnet system. The electrical voltage produced by the opposing movement of the charges is picked up and evaluated by measuring electrodes in contact with the medium, wherein the voltage, in a close approximation, is proportional to the flow of the medium as well as to the amount of magnetic field strength of the magnetic field.

Further developments of magnetic-inductive flow meters include applying a pulsed magnetic field to the medium, wherein the magnetic field assumes an opposite polarity with each clock cycle. This makes it possible to compensate for effects which influence the electrode voltage to be measured and falsify the flow measurement. One such effect is, for example, the formation of a dipole layer at an interface between the measuring electrode and medium so that an electrode voltage can be measured even when the medium is stationary, so that the flow meter displays an apparent flow.

In order to accelerate the transition between the magnetic fields of two clock cycles, a shot voltage is applied to a coil system of the magnet system during a cycle in a shot phase in a further development of the magnetic-inductive flow meter, the shot voltage being greater in value than a measurement voltage of a measuring phase following the shot phase. Thus, the flow meter is in a measuring phase for a longer time, thereby increasing its performance. Such a magnetic-inductive flow meter is disclosed in application DE 102014107200A1.

The response of the coil system to an electrical voltage applied to the coil system depends on the impedance of the system, which impedance is temperature-dependent, among other things. A change in the temperature of the coil system thus leads to an undesired change in the behavior of the magnetic-inductive flow meter. The object of the invention is therefore to propose a method for operating a magnetic-inductive flow meter and a magnetic-inductive flow meter which has at least a higher temperature stability. The object is achieved by a method according to independent claim 1, and by a magnetic-inductive flow meter according to independent claim 13.

A method according to the invention for operating a magnetic-inductive flow meter for measuring the flow rate or the volumetric flow of a medium in a measuring tube is implemented by a magnetic-inductive flow meter, which magnetic-inductive flow meter comprises:

which magnetic-inductive flow meter comprises:

a measuring tube for guiding the medium;

a magnet system with at least one coil system for generating a magnetic field in the medium, wherein the magnetic field is substantially perpendicular to a measuring tube axis, the magnetic field being caused by applying an electric voltage to the coil system;

at least one pair of measuring electrodes arranged in the measuring tube for detecting an electrode voltage induced by the magnetic field in the medium, the electrode voltage being substantially proportional to the flow rate and the field strength of the magnetic field;

a measuring/operating circuit for operating the magnet system and evaluating the electrode voltage;

wherein the method comprises:

generating the magnetic field during a feeding phase, the feeding phase having a shot phase and a measuring phase,

wherein during the shot phase, a shot voltage is applied to the coil system, and wherein during the measuring phase, a measurement voltage is applied to the coil system, the magnitude of the shot voltage being different than the magnitude of the measurement voltage,

wherein the magnetic field is substantially constant at least in sections during the measuring phase, a measured value of the electrode voltage being used to calculate the flow rate of the medium during the measuring phase;

measuring a coil current that flows through the coil system;

switching from the shot phase to the measuring phase as soon as the coil current reaches a limit value;

detecting an actual time period from the beginning of the feeding phase until the limit value is reached;

generating the magnetic field during an Xth subsequent feeding phase,

wherein

a shot voltage of the Xth subsequent feeding phase is adapted as a function of the actual time period and a target time period in order to reduce a deviation of an actual time period of the Xth subsequent feeding phase from the target time period, wherein X is a natural number.

In an embodiment of the method, the measuring phase has a transition phase following the shot phase, wherein the magnetic field is variable during the transition phase.

In one embodiment of the method, the magnetic field of an adjacent feeding phase has an inverted polarity.

In one embodiment of the method, a measurement voltage is adapted to the Xth subsequent feeding phase.

In one embodiment of the method, the shot voltage and/or the measuring voltage are adapted to the next or one after the next feeding phase so that the following applies: X=1 or X=2.

In one embodiment of the method, the shot voltage and the measuring voltage are controlled independently of one another.

In one embodiment of the method, the magnitude of the shot voltage (U_{Shot Z+X}) of the Xth subsequent feeding phase is determined:

|U_{Shot Z+X}|=|U_{Shot Z}*(t_{Tat Z}/t_{Soll})\hat{ }y1|,y1 [symbol] (0.3]

In one embodiment of the method, the following applies: y1=1.

In one embodiment of the method, the magnitude of the shot voltage (U_{Shot Z+X}) of the Xth subsequent feeding phase is determined as follows:

|U_{Shot Z+X}|=|U_{Shot Z}*(t_{M}/t_{Soll})\hat{ }y2|,y2 [symbol] (0.3],

wherein t_{M} is a mean value of actual time periods of previous feeding phases and the actual time period t_{Tat Z}.

In one embodiment of the method, the following applies: y2=1.

In one embodiment of the method, only the actual durations of previous feeding phases having the same polarity of the magnetic field are taken into account in the calculation of the mean value t_{M}.

In one embodiment of the method, a difference of measured values of the electrode voltage or a difference of electrode voltages of the measuring phases of two successive feeding phases is used to determine a flow measurement.

A magnetic-inductive flow meter according to the invention comprises:

a measuring tube which is configured to conduct the medium;

a magnet system having at least one coil system, which magnet system is configured to generate a magnetic field in the medium, the magnetic field being substantially perpendicular to a measuring tube axis;

at least one pair of measuring electrodes arranged in the measuring tube, which electrodes are configured to detect a voltage induced by the magnetic field in the medium, which voltage is substantially proportional to the flow rate and the field strength of the magnetic field;

a measuring/operating circuit that is configured to operate the magnet system, to detect a coil current and to evaluate the voltage detected by the pair of measuring electrodes.

In one embodiment, the magnet system comprises at least one field suppression guide which is designed to at least partially guide the magnetic field outside the measuring tube between the measuring tube side opposite the coil system and the coil system.

The invention will be described in the following with reference to exemplary embodiments:

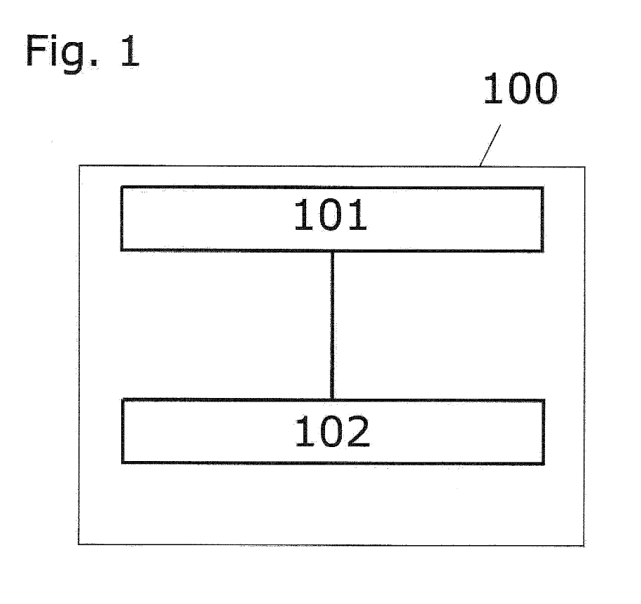

FIG. 1 illustrates a schematic process flow for operating a magnetic-inductive flow meter according to the invention.

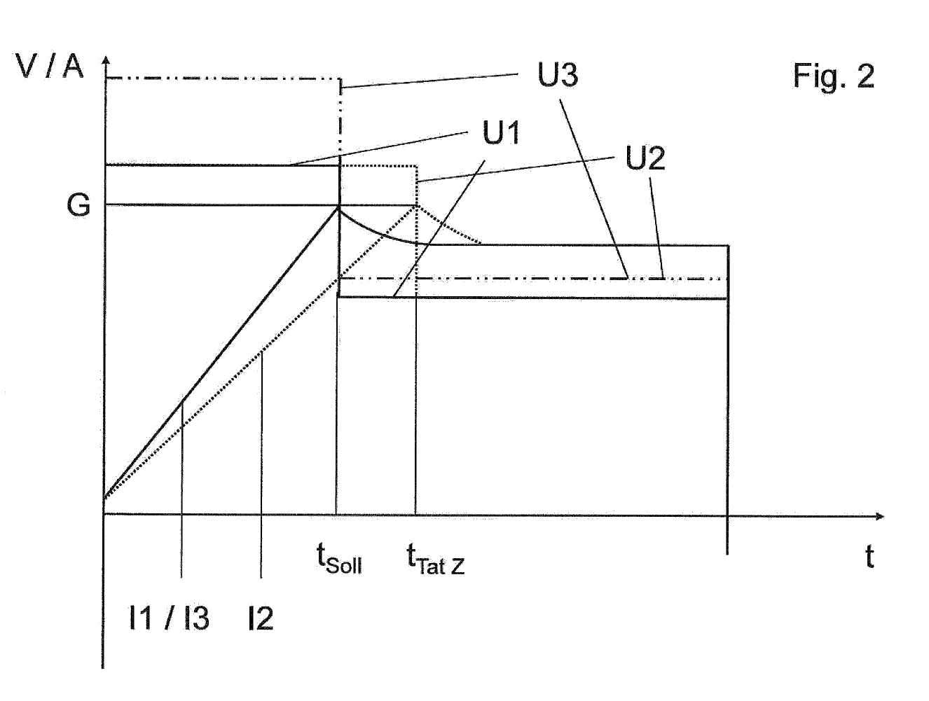

FIG. 2 illustrates schematic curves of a coil voltage and a coil current of a coil system of a magnetic-inductive flow meter according to the invention.

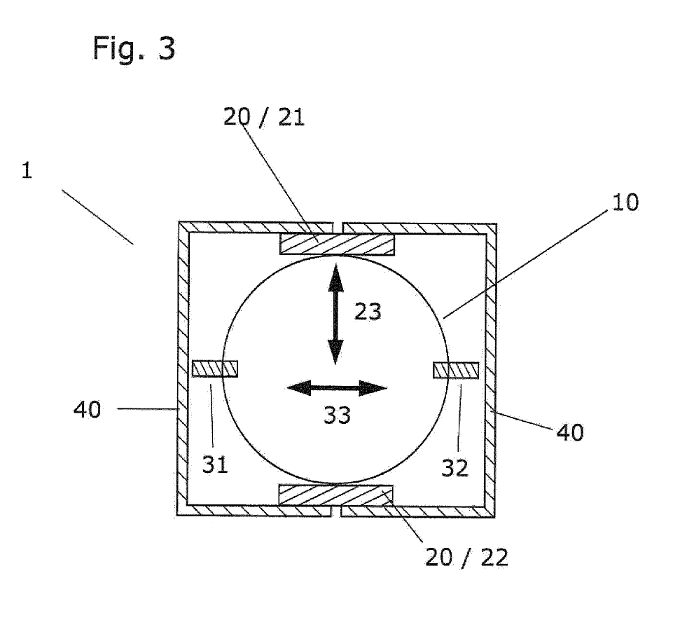

FIG. 3 illustrates a cross-section through a magnetic-inductive flow meter according to the invention.

FIG. 1 illustrates the sequence of a method 100 according to the invention for operating a magnetic-inductive flow meter (1) for measuring the flow rate or the volumetric flow of a medium in a measuring tube, wherein the magnetic-inductive flow meter (1) comprises:

a measuring tube (10) for guiding the medium;

a magnet system (20) having at least one coil system (21, 22) for generating a magnetic field in the medium, wherein the magnetic field is substantially perpendicular to a measuring tube axis, the magnetic field being caused by applying an electric voltage to the coil system (21, 22);

at least one pair of measuring electrodes (31, 32) arranged in the measuring tube (10) for detecting an electrode voltage induced by the magnetic field in the medium, the electrode voltage being substantially proportional to the flow rate and the field strength of the magnetic field;

a measuring/operating circuitry for operating the magnet system (20) and evaluating the electrode voltage;

wherein the method (100) comprises:

generating the magnetic field during a feeding phase, the feeding phase having a shotting phase and a measuring phase,

wherein during the shot phase, a shot voltage (U_{Shot N}) is applied to the coil system (21, 22), and wherein during the measuring phase, a measurement voltage (U_{Mess N}) is applied to the coil system (21, 22), the magnitude of the shot voltage being greater than the magnitude of the measurement voltage,

wherein the magnetic field is substantially constant during the measuring phase, a measured value of the electrode voltage being used during the measuring phase to calculate the flow rate of the medium;

wherein a coil current is measured that flows through a coil system 21, 22 of the magnet system 20, and wherein there is a switch from the shot phase to the measurement phase as soon as the coil current reaches a limit value G;

wherein in a first method step 101 an actual time period t_{Tat Z} is detected which requires a coil current of a coil system of a magnet system of a magnetic-inductive flow meter in order to reach a limit value G;

wherein during an Xth subsequent feeding phase, a magnetic field is generated, wherein X is a natural number,

wherein in a second method step (102) a shot voltage (U_{Shot Z+X}) of the Xth subsequent feeding phase is adapted as a function of the actual time period (t_{Tat Z}) and a target time period (t_{Soll}) in order to reduce a deviation of an actual time period (t_{Tat Z+X}) of the Xth subsequent feeding phase from the target time period.

Typically, the magnetic fields of adjacent feeding phases have reversed polarity, in which case the subsequent feeding phase to be adapted is preferably in particular the next feeding phase thereafter, so that X=2 applies.

For example, the magnitude of the shot voltage U_{Shot Z+X} of the Xth subsequent feeding phase can be determined as follows:

|U_{Shot Z+X}|=|U_{Shot Z}*(t_{Tat Z}/t_{So11})\hat{ }y1|, y1 [symbol] (0.3], wherein the sign of U_{Shot Z+X} is given by the polarity of the magnetic field. By selecting the parameter y1, an adaptation speed of the shot voltage can be set.

For example, the magnitude of the shot voltage U_{Shot Z+X} of the Xth subsequent feeding phase can also be determined as follows:

|U_{Shot Z+X}|=|U_{Shot Z}*(t_{M}/t_{Soll})\hat{ }y2|, y2 [symbol] (0.3], wherein the sign of U_{Shot Z+X} is given by the polarity of the magnetic field. By selecting the parameter y2, an adaptation speed of the shot voltage can be set,

wherein t_{M} is a mean value of actual time periods of previous feeding phases and the actual time period t_{Tat Z}.

FIG. 2 illustrates schematic curves of the coil voltage and the coil current of the coil system of the magnetic-inductive flow meter according to the invention for various situations over a feeding phase. Switching from the shot phase to the measuring phase occurs as soon as the coil current I1, I2, I3 reaches the limit value G, wherein the coil current abates to a substantially constant value in a transition phase of the measuring phase. In the case of a magnetic-inductive flow meter in which magnetic fields of adjacent feeding phases have inverse polarity, wherein adjacent feeding phases connect to one another without interruption, the starting value of the current I1, I2 or I3 is not equal to zero, wherein the value of the current over the course of the shot phase assumes a sign opposite to the sign of the starting value. If a rest phase occurs between two adjacent feeding phases in which the coil system is not energized with an electrical voltage, the starting value of the current I1, I2 or I3 is equal to zero.

What is essential for a flow measurement with less uncertainty in a magnetic-inductive flow meter is a curve of the coil current that is constant over various feeding phases, because the magnetic field is set via the coil current, which magnetic field affects an electrode voltage. A variation of the coil current curve over various feeding phases resulted in an apparent flow change and would result in a distortion of a flow measurement.

The voltage curve U1 and the current curve I1 curves show target curves as they look, for example, while initially operating the flow meter.

The voltage curve U2 and the current curve I2 show curves as they appear when the flow meter is heated if the shot voltage and the measuring voltage remain unchanged. Upon heating the flow meter, for example, by a hot medium, resistors of the coil system 21, 22 typically expand so that attaining the limit value G of the coil current by the coil current I2 takes longer than in the case of the current curve I1. Furthermore, a lower current would be set during the measuring phase with measuring voltage unchanged, so that in practice a measurement voltage adjustment is carried out, so that a substantially consistently strong magnetic field acts on the medium over different measuring phases. In order to ensure a constant current curve over the entire feeding phase when the flow meter changes in temperature, it is necessary to adapt the shot voltage and the measuring voltage.

The voltage curve U3 has an adapted shot voltage and an adapted measurement voltage, so that the current profile I3 substantially corresponds to the current profile I1. It is important in the adaptation that the shot voltage and the measuring voltage have to be adjusted independently of one another. In the measuring phase, the total resistance of the coil system 21, 22 is basically an ohmic resistance, while in the shot phase, the total resistance is dependent on the ohmic resistance and the inductance of the coil system.

Typically, a constant phase of the magnetic field lasts for 1 to 60 milliseconds during a measuring phase, wherein a feeding phase can last between 15 milliseconds and 1 second.

In the case of a cooling of the flow meter or in the case of a flow meter with atypical cooling system resistance, which when heated becomes smaller, corresponding considerations apply.

FIG. 3 illustrates a cross section through a magnetic-inductive flow meter 1 according to the invention having a measuring tube 10, a magnet system 20 with coil systems 21 and 22, measuring electrodes 31 and 32 and a field return 40. The magnet system applies a magnetic field which is aligned in the direction of arrow 23 to the medium in the measuring tube 10. The magnetic field and the flow of the medium through the measuring tube ensure that an electrode voltage is generated in the direction of arrow 33.

### LIST OF REFERENCE SYMBOLS

1 Magnetic-inductive flow meter
10 Measuring tube
20 Magnet system
21, 22 Coil system
23 Direction of the magnetic field
31, 32 Measuring electrodes
40 Field return
100 Method
101 First method step
102 Second method step
U1 First voltage curve
U2 Second voltage curve
U3 Third voltage curve
I1 First current profile
I2 Second current profile
I3 Third current profile
t_{Soll} Target time period
t_{Tat Z} Actual time period
G Limit value of coil current

1-14. (canceled)

15. A method for operating a magnetic-inductive flow meter for measuring a flow rate or a volumetric flow of a medium in a measuring tube, the magnetic-inductive flow meter comprising:
a measuring tube for guiding the medium;
a magnet system having at least one coil system for generating a magnetic field in the medium, wherein the magnetic field is substantially perpendicular to a measuring tube axis, wherein the magnetic field is caused by applying an electric voltage to the coil system;
at least one pair of measuring electrodes arranged in the measuring tube for detecting an electrode voltage induced by the magnetic field in the medium, the electrode voltage being substantially proportional to the flow rate and a field strength of the magnetic field;
an operating circuit for operating the magnet system and evaluating the electrode voltage;
wherein operating comprises:
generating the magnetic field during a feeding phase, wherein the feeding phase has a shot phase and a holding phase,
wherein during the shot phase, a shot voltage (U_{Shot Z}) is applied to the coil system, and
wherein during a measuring phase a measurement voltage (U_{Mess Z}) is applied to the coil system, a magnitude of the shot voltage being greater than the magnitude of the measurement voltage,
wherein the magnetic field is substantially constant in sections during the measuring phase,
wherein a measured value of the electrode voltage is used during the measuring phase to calculate the flow rate of the medium;
measuring a coil current that flows through the coil system;
switching from the shot phase to the measuring phase as soon as the coil current reaches a limit value G;
detecting an actual time period (t_{Tat Z}) from a beginning of the feeding phase until the limit value (G) is reached; and
generating the magnetic field during an Xth subsequent feeding phase,
wherein the shot voltage (U_{Shot Z+X}) of the Xth subsequent feeding phase is adapted as a function of the actual time period (t_{Tat Z}) and a target time period (t_{Soll}) in order to reduce a deviation of an actual time period (t_{Tat Z+X}) of the Xth subsequent feeding phase from the target time period, wherein X is a natural number.

16. The method of claim 15, wherein the measuring phase has a transition phase following the shot phase, the magnetic field being variable during the transition phase.

17. The method of claim 15, wherein the magnetic field of an adjacent feeding phase has an inverse polarity.

18. The method of claim 15, wherein the measurement voltage is adapted to the Xth subsequent feeding phase.

19. The method of claim 15, wherein the shot voltage and/or the measurement voltage is adapted to the next or one after the next feeding phase so that the following applies: X=1 or X=2.

20. The method of claim 19, wherein the shot voltage and the measurement voltage are regulated independently of one another.

21. The method of claim 15, wherein the magnitude of the shot voltage (U_{Shot Z+X}) of the Xth subsequent feeding phase is determined as follows:

|U_{Shot Z+X}|=|U_{Shot Z}*(t_{Tat Z}/t_{Soll})\hat{ }y1|,y1 [symbol] (0.3].

22. The method of claim 21, wherein the following applies: y1=1.

23. The method of claim 15, wherein the magnitude of the shot voltage (U_{Shot Z+X}) of the Xth subsequent feeding phase is determined as follows:

|U_{Shot Z+X}|=|U_{Shot Z}*(t_{M}/t_{Soll})\hat{ }y2|,y2 [symbol] (0.3],
wherein t_{M} is a mean value of actual time periods of previous feeding phases and the actual time period t_{Tat Z}.

24. The method of claim 23, wherein the following applies: y2=1.

25. The method of claim 23, wherein only actual durations of previous feeding phases having a same polarity of the magnetic field are taken into account in the calculation of the mean value t_{M}.

26. The method of claim 15, wherein a difference of measured values of the electrode voltage or a difference of electrode voltages of the measuring phases of two successive feeding phases is used to determine a flow measurement.

27. A magnetic-inductive flow meter for measuring a flow rate or a volumetric flow of a medium, comprising:
a measuring tube which is configured to conduct the medium;
a magnet system having at least one coil system, wherein the magnet system is configured to generate a magnetic field in the medium, the magnetic field being substantially perpendicular to a measuring tube axis;
at least one pair of measuring electrodes arranged in the measuring tube, wherein the measuring electrodes are configured to detect a voltage induced by the magnetic field in the medium, wherein the voltage is substantially proportional to the flow rate and a field strength of the magnetic field; and
an operating circuit that is configured to operate the magnet system, to detect a coil current and to evaluate the voltage detected by the pair of measuring electrodes, the operating circuit being configured to:
generate the magnetic field during a feeding phase, wherein the feeding phase has a shot phase and a holding phase,
wherein during the shot phase, a shot voltage (U_{Shot Z}) is applied to the coil system, and
wherein during a measuring phase a measurement voltage (U_{Mess Z}) is applied to the coil system, a magnitude of the shot voltage being greater than the magnitude of the measurement voltage,
wherein the magnetic field is substantially constant in sections during the measuring phase,
wherein a measured value of an electrode voltage is used during the measuring phase to calculate the flow rate of the medium;
measure the coil current;
switch from the shot phase to the measuring phase as soon as the coil current reaches a limit value G;
detect an actual time period (t_{Tat Z}) from a beginning of the feeding phase until the limit value (G) is reached; and
generate the magnetic field during an Xth subsequent feeding phase,
wherein the shot voltage (U_{Shot Z+X}) of the Xth subsequent feeding phase is adapted as a function of the actual time period (t_{Tat Z}) and a target time period (t_{Soll}) in order to reduce a deviation of an actual time period (t_{Tat Z+X}) of the Xth subsequent feeding phase from the target time period, wherein X is a natural number.

28. The magnetic-inductive flow meter of claim 27, wherein the magnet system comprises at least one field return which is designed to guide the magnetic field outside the measuring tube between the measuring tube side opposite the coil system and the coil system.
